(19) United States
(12) Patent Application Publication
(10) Pub. No.: US 2024/0383693 A1
(43) Pub. Date: Nov. 21, 2024

(54) SYSTEMS AND METHOD FOR AN EARLY DETECTION OF A MALFUNCTION OF A CONVEYOR UNIT OF A CONVEYOR SYSTEM OF AN OVEN, AND OVEN COMPRISING AT LEAST ONE SUCH SYSTEM

(71) Applicant: BELVAC PRODUCTION MACHINERY, INC., Lynchburg, VA (US)

(72) Inventors: Ulf REINHARDT, Teutschenthal (DE); Wilko HARMS, Wittmund (DE)

(21) Appl. No.: 18/684,488

(22) PCT Filed: Jul. 11, 2022
(86) PCT No.: PCT/DE2022/100495

§ 371 Date: Feb. 22, 2024

(30) Foreign Application Priority Data
Aug. 20, 2021 (DE) 10 2021 121 656.7

(51) Int. Cl. B65G 43/02; B65G 45/02; F26B 15/12; G05B 23/02

(52) U.S. Cl. CPC B65G 43/02; B65G 45/02; F26B 15/12; G05B 23/0283; B65G 2203/0283; B65G 2207/38

(57) ABSTRACT

The invention relates to a system and a method for an early detection of a malfunction of a conveyor unit of a conveyor system of an oven and to an oven, in particular a pin oven, comprising at least one such system. One of the systems comprises: at least one measuring unit which is designed to detect at least one operating parameter of the conveyor system. The system additionally comprises a controller which is designed to compare the operating parameter with a target operating parameter; detect a deviation of the operating parameter from the target operating parameter at a detection time; and output a warning signal if the deviation is greater than or equal to a specified value after a specified duration, wherein the duration starts at the detection time.

### CROSS-REFERENCE TO RELATED APPLICATIONS

This application is a U.S. national stage of International Application No. PCT/DE2022/100495, filed Jul. 11, 2022, which claims the benefit of and priority to German Patent Application No. 10 2021 121 656.7, filed Aug. 20, 2021, each of which is hereby incorporated by reference herein in its entirety.

### FIELD

The invention relates to a system and a method for an early detection of a malfunction of a conveyor system of an oven and to an oven, in particular a pin oven, comprising at least one such system.

### BACKGROUND

The production process of (metal) objects, in particular of cans or parts of cans, involves performing several process steps that are each separated by cleaning processes. These cleaning processes require a drying process.

A drying oven, for example a PIN oven comprising a chain, usually a metal chain, for conveying the cans is provided for a drying process. The metal chain comprises transport pins that carry the cans through an opening of the latter and convey the cans through the oven. The metal chain represents a wear part that—in the event of an unplanned failure—causes considerable costs due to a loss of production.

In particular a metal chain should be lubricated with a lubricant to reduce or even avoid wear of the metal chain. However, an excessive supply of lubricant introduces chained hydrocarbons into the drying oven (usually heated to 230° C.) and whose cans are no longer washed before the next process step. Consequently, the cans should be substantially free of oils and lubricants, for example in order to avoid jeopardizing a subsequent painting of the inside of the can. Lubricant is usually supplied to a chain run of the metal chain. There, the rotation of a chain sprocket is used to carry out a minimum lubrication of the metal chain, as determined by experience. However, this method does not take into account an actual load on the chain, thus increasing the risk of a malfunction and unplanned downtime of the metal chain.

The transport pins of the metal chain can also be subject to wear and tear and/or can break off and/or bend, which prevents loading the transport pins with cans and in turn leads to a loss of the can, since a decorator places the cans onto the metal chain regardless of the presence of a transport pin. If a transport pin breaks while a can is transported by the former, this transport pin and this can can fall down in the drying oven. Furthermore, cans can fall down from the transport pins before the drying oven, in the drying oven, and in the cooling zone. Empty spaces are created along the metal chain in addition to the problem that these fallen transport pins and cans can jeopardize the processes as such. There is no ongoing check of the transport pins. Instead, the metal chain is checked manually for breaks during maintenance work.

It is therefore an object of the invention to remedy one or more of the aforementioned disadvantages by a system and a method for an early detection of a malfunction of a conveyor unit of an oven, and an oven, in particular a pin oven, comprising such a system. In particular, it is an object of the invention to determine an expected service life of the conveyor unit of the oven in order to reduce or even avoid unplanned downtime.

### SUMMARY

According to one embodiment, a system for early detection of a malfunction of a conveyor unit of a conveyor system for conveying container units along a drying path of an oven is disclosed. The system comprises at least one measuring unit configured to detect at least one operating parameter of the conveyor system. The system further comprises a controller configured to compare the operating parameter to a target operating parameter, determine a deviation of the operating parameter from the target operating parameter at a detection time, and output a warning signal if the deviation is greater than or equal to a predetermined value after a predetermined duration. The duration begins with the detection time.

According to another embodiment, a system for an early detection of a malfunction of a conveyor unit of a conveyor system for conveying container units along a drying path of an oven is disclosed. The system comprises at least one measuring unit configured to detect at least one operating parameter of the conveyor system that has an influence on a service life of a conveyor unit of the conveyor system. The system further comprises a controller configured to determine an expected service life of the conveyor unit based on the at least one operating parameter and output a maintenance signal based on the expected service life of the conveyor unit that characterizes an expected appointed maintenance time of the conveyor unit.

According to another embodiment, a method for an early detection of a malfunction of a conveyor unit of a conveyor system for conveying container units, along a drying path of an oven is disclosed. The method comprises detecting at least one operating parameter of the conveyor system. The method further comprises comparing the operating parameter to a target operating parameter. The method further comprises determining a deviation of the operating parameter from the target operating parameter at a detection time. The method further comprises outputting a warning signal if the deviation is greater than or equal to a predetermined value after a predetermined duration, wherein the duration begins with the detection time.

According to another embodiment, a method for an early detection of a malfunction of a conveyor unit of a conveyor system for conveying container units along a drying path of an oven is disclosed. The method comprises detecting at least one operating parameter of the conveyor system that has an influence on a service life of a conveyor unit of the conveyor system. The method further comprises determining an expected service life of the conveyor unit based on the at least one operating parameter. The method further comprises outputting a maintenance signal based on the expected service life of the conveyor unit that characterizes an expected appointed maintenance time of the conveyor unit.

### BRIEF DESCRIPTION OF THE DRAWINGS

Preferred embodiments are explained by way of example with reference to the enclosed figures. These show in

FIG. 1: a schematic, two-dimensional side view of a pin oven;

FIG. 2: a schematic, two-dimensional detail view of the pin oven shown in FIG. 1;

FIG. 3 a schematic view of an exemplary method for outputting a warning signal; and

FIG. 4: a schematic view of an exemplary method for outputting a maintenance signal.

In the figures, identical or essentially functionally identical or similar elements are designated with the same reference symbols.

### DETAILED DESCRIPTION

This task is solved according to a first aspect with a system for an early detection of a malfunction of a conveyor unit of a conveyor system of an oven. The system comprises at least one measuring unit adapted to detect at least one operating parameter of the conveyor system, in particular an operating parameter that influences the conveyor unit. The system further comprises a controller adapted to compare the operating parameter to a target operating parameter and to detect a deviation of the operating parameter from the target operating parameter at a detection time. The controller is further adapted to output a warning signal if the deviation is greater than or equal to a predetermined value after a predetermined duration, wherein the duration starts at the detection time.

The invention is based on the knowledge that a malfunction can be detected in advance by detecting deviations from the target operating parameter. For example, a defective bearing is characterized in that the friction and/or temperature of the bearing is increased. Correspondingly, the bearing may break. By detecting the increased friction or the temperature, the warning signal can be output in advance to replace the bearing and prevent a malfunction. Furthermore, the invention is based on the knowledge that various operating parameters of the conveyor system, in particular the conveyor unit and/or the oven, have an influence on the service life of the conveyor unit. Without limitation, these operating parameters lead to wear on the conveyor unit or represent a load on the conveyor unit. By detecting these operating parameters, a progression of the wear of the conveyor unit and/or an expected appointed maintenance time can be determined by determining a deviation from the target operating parameter. For example, if the temperature of the conveyor unit increases significantly over a short time with constant settings or conditions, it can be concluded that a bearing of the conveyor unit is at least partially defective. The temperature will remain elevated over the predetermined duration and is therefore not a measurement error and/or measurement inaccuracy. Accordingly, prior to an event that has a negative influence on production or drying by means of the oven, the conveyor unit can be maintained and/or individual elements of the conveyor unit can be repaired and/or exchanged in order to prevent this event. Consequently, in extreme cases, a shutdown or failure of the conveyor unit can be avoided and reliable production can be guaranteed. A stoppage of the conveyor unit during production can also be scheduled to reduce the costs to a minimum during the stoppage and when the conveyor unit is restarted.

The system can comprise one or more sections for drying the container units of the oven, in particular a pin oven. The system is in particular suitable for the oven, in particular the pin oven. The oven can comprise the one or more sections for drying and thus for producing container units. Viewed along a production direction, a container unit is subjected to different process steps of the several sections. As already mentioned at the outset, these include one or more cleaning processes and correspondingly one or more drying processes. Consequently, the system can comprise one or more of the sections that carry out at least the drying processes.

The conveyor system can comprise the conveyor unit and/or other units necessary for transporting the container units. The system can comprise the conveyor system and/or individual elements thereof.

The detection time is the time at which the controller detects the deviation.

The conveyor unit can be a chain conveyor that comprises transport pins arranged at a distance from one another along its main extension direction. The container units can be positioned by means of the transport pins. For this purpose, the transport pins can protrude into the container units, which are open on one end. The conveyor unit can be adapted to convey the container units along a conveying direction through the system or the oven.

The target operating parameter can be a target operating parameter determined by a user and/or a predetermined target operating parameter. In particular, the target operating parameter can be selected individually for each operating parameter. The target operating parameter specifies a reference value for the operating parameter. In particular, the target 20 operating parameter can be selected such that during production of the container units, this target operating parameter guarantees cost-effective, efficient, in particular energy-efficient production and/or production in compliance with directives, in particular statutory directives.

The system can comprise one, two, or more measuring units. The following discussion regarding one measuring unit can be applied to each additional measuring unit.

The measuring unit can be adapted to record the at least one operating parameter at time intervals, in particular at regular time intervals. Alternatively or additionally, the measuring unit can be adapted to detect the at least one operating parameter during the operation of the system and/or the oven. The measuring unit can in particular be adapted to continuously detect the at least one operating parameter during operation. The measuring unit can 30 furthermore be coupled to the controller by signal technology.

The operating parameter can comprise at least one parameter of the conveyor system, in particular the conveyor unit and/or at least one parameter of the oven.

The operating parameter can comprise one of the following: a friction, in particular an averaged friction, a damage, an elongation, a load, a temperature, a torque of drive unit driving the conveyor system, an ambient temperature of the conveyor system, a lubrication cycle and a lubrication of the conveyor system, in particular of the conveyor unit, and a fan speed of a fan unit of the oven. The averaged friction is a friction determined from two or more friction values of the conveyor system, in particular the conveyor unit. The operating parameter can comprise one of the following: a friction, a damage, an elongation, a load, a temperature, an ambient temperature, a lubrication cycle and a lubrication of at least one individual element of the conveyor system.

The controller can further be adapted to determine an appointed maintenance time based on the deviation if the deviation is greater than or equal to the predetermined value during and/or after the predetermined duration, wherein the warning signal further characterizes the appointed maintenance time.

The measuring unit can be adapted to detect the elongation based on a cylinder position of a conveyor unit tension controller of the conveyor unit, and/or wherein the predetermined value is greater than or equal to 5%, 3%, in particular 1%.

The target operating parameter, the predetermined value, and the duration can be selected based on the operating parameter to be recorded. Depending on the operating parameters, the deviations can be larger or smaller, and accordingly it can be necessary to select the predetermined values and the durations individually for the operating parameters.

The operating parameter can comprise at least one of the following: the torque, the elongation, the friction and/or the temperature of the conveyor system and/or of the at least one individual element; wherein the controller—when detecting the deviation—is further adapted to: output a lubrication command to a lubrication unit for lubricating the conveyor system and/or the at least one individual element with a lubricant within the predetermined duration. The controller can in particular be adapted to output the lubrication command at the detection time and/or at a lubrication time that represents a predetermined time interval to the detection time and is within the predetermined duration. For example, if increased friction or a deviation from the target operating parameter is detected, this can indicate insufficient lubrication and does not necessarily indicate a defective element of the conveyor unit. As a result, lubrication can first be increased to thus potentially reduce friction. If the friction is reduced successfully, no warning signal is issued.

The system can comprise the lubrication unit.

The controller can further be adapted to determine a lubricant quantity for lubricating the conveyor system and/or the at least one individual element on the basis of at least the deviation, and the lubrication command characterizes the determined lubricant quantity, wherein the lubricant quantity is in particular further determined on the basis of a predetermined minimum lubricant limit, a predetermined maximum lubricant limit and/or an actual lubricant quantity. In particular with regard to introducing lubricants into the oven, it can be necessary to not exceed the maximum lubricant limit.

The measuring unit can be adapted to determine position information of the at least one individual element if the deviation is greater than or equal to, or greater than, the predetermined value after the predetermined duration; wherein the position information characterizes at least one of the following: an actual position and/or an expected position of the at least one individual element. The warning signal can comprise the position information. A position of the individual element can thus be communicated to the user by means of the warning signal and said individual element can be inspected and/or exchanged.

The measuring unit can be adapted to determine the load on the conveyor system, in particular the conveyor unit, based on oscillations of the conveyor unit. Alternatively or additionally, the controller can be adapted to determine a risk for the container units based on the detected oscillations. The controller can in particular be adapted to control the drive unit based on the detected oscillations, preferably such that the risk to the container units is reduced to a minimum risk.

The controller can be adapted to control the drive unit such that the detected oscillations are reduced and/or compensated. The conveyor unit can comprise transport pins for conveying the container units through the oven, and the controller can in particular be adapted to control the drive unit based on distances between the transport pins such that the detected oscillations are reduced and/or compensated.

The controller can be adapted to control the drive unit and/or the conveyor unit, in particular a conveyor unit tension of a conveyor unit tension controller of the conveyor system based on at least one of the following: an age of the conveyor unit and/or the at least one individual element, a conveyor speed of the conveyor unit, the at least one operating parameter, a container unit loss upstream, along, and/or downstream of a section of the oven. The conveyor unit tension of the conveyor unit tension controller can be a chain tension of the chain tension controller. The conveyor unit tension, in particular the chain tension, can be determined based on a cylindrical force of the cylinder.

The measuring unit can be adapted to determine the friction of the conveyor system, in particular of the conveyor unit and/or the friction of the at least one individual element based on a power consumption parameter of the drive unit, wherein the power consumption parameter comprises at least one of the following: an actual value of a power consumption, a power consumption versus time, and a change of the power consumption. The measuring unit can in particular be adapted to additionally determine an ambient temperature of the conveyor system, in particular of the conveyor unit and/or the at least one individual element, in order to determine the power consumption parameter.

The measuring unit can be adapted to determine the friction of the conveyor unit based on the detected temperature of the conveyor unit and/or the friction of the at least one individual element based on the detected temperature of the at least one individual element. The measuring unit can in particular be adapted to record a bearing temperature of a bearing of the conveyor unit.

The measuring unit can be adapted to determine a bearing state of one or more bearings of the conveyor unit as the friction, the damage, and/or load on the conveyor unit and/or of the one or more bearings of the conveyor unit, wherein the controller can in particular be adapted to control the lubrication unit based on the friction, the damage, and/or the load on the conveyor unit and/or the one or more bearings of the conveyor unit.

The measuring unit can be adapted to determine the friction of the conveyor unit based on a control temperature of the conveyor unit and/or of the at least one individual element upstream and/or downstream of a guide unit of the conveyor unit, wherein the controller can in particular be adapted to determine an adjustment error of the guide unit based on the determined friction upstream and/or downstream of the guide unit of the conveyor unit and/or the at least one individual element, and to output and/or determine a correction signal for correcting the guide unit together with the warning signal.

The measuring unit can be adapted to detect the load based on a torque of the drive unit. The controller can in particular be adapted to determine at least one defective bearing and/or an insufficient lubrication of the conveyor unit if the deviation is greater than or equal to, or greater than, the predetermined value after the predetermined duration.

The measuring unit can be adapted to determine the damage to the conveyor unit based on a breakage and/or a absence of at least one transport pin of the transport pins of the conveyor unit. With respect to the transport pins, the operating parameter can be a number of transport pins of the conveyor unit. The target operating parameter can describe a lower limit of the transport pins below which the number of transport pins must not drop.

The object is further solved according to a second aspect by a system for an early detection of a malfunction of a conveyor unit of a conveyor system for conveying container units, in particular cans, along an oven, comprising at least one measuring unit, adapted to detect at least one operating parameter of the conveyor system that has an influence on a service life of a conveyor unit of the conveyor system. The system further comprises a controller adapted to: (1) determine an expected service life of the conveyor unit based on the at least one operating parameter; (2) output a maintenance signal based on the expected service life of the conveyor unit that characterizes an expected appointed maintenance time of the conveyor unit.

In order to avoid repetitions, we note that previously and subsequently described explanations regarding the first aspect can be applied to, and combined with, the second aspect. The following explanations regarding the second aspect can also be applied to, and combined with, the first aspect. In particular, embodiments relating to the at least one measuring unit, the controller, the conveyor system, the conveyor unit, individual elements of the conveyor system and/or the conveyor unit of the first aspect can be applied to, and combined with, the second aspect and vice versa.

The controller is adapted to determine the expected service life based on the at least one operating parameter. The controller can further be adapted to further determine the expected service life based on an expected service life of the conveyor unit, which is a parameter specified by a manufacturer of the conveyor unit. The expected service life can be specified taking into account various operating parameters, such as an average conveyor belt speed, an average operating load, an average number of transported container units, and an average temperature. Based on these manufacturer-specified specifications and/or parameters, deviations from these can be determined while the conveyor unit is in operation in order to determine a positive or negative impact on the expected service life. The expected service life, i.e. the actual service life of the conveyor unit, can be determined accordingly. For example, a higher average operating load can lead to a reduction of the expected service life compared to the expected service life due to the higher load on the conveyor unit. By contrast, a lower average operating load can lead to a longer expected service life compared to the expected service life. In addition, or as an alternative, to the manufacturer's specification, previous measurements and/or information from previous or already used conveyor units and/or their service lives can be used by the controller to determine the expected service life based on the measured operating parameters and/or information and/or service life of previous conveyor units. Alternatively or additionally, empirical values obtained by personnel and/or operators of the system or the oven can be entered to determine the expected service life.

Starting up the conveyor unit can lead to an additional load on the conveyor unit since the conveyor unit must be accelerated. The inventors recognized that an acceleration of the conveyor unit, in particular without an adjusted acceleration, reduces the expected service life of the conveyor unit. The expected service life of the conveyor unit is reduced by up to 15%, in particular 10%, if the conveyor unit is accelerated between nine thousand to eleven thousand, in particular ten thousand times, without adjusted, in particular abrupt acceleration. If the conveyor unit is driven or accelerated abruptly, this then represents an increased load for the conveyor unit, which leads to the reduced expected service life. The adjusted acceleration means that the conveyor unit is initially driven with a first acceleration that is increased, in particular continuously, within a predetermined duration up to a second acceleration. It is thus possible to reduce or even eliminate an abrupt start-up or acceleration of the conveyor unit to keep the load as low as possible, in particular when starting up the conveyor unit.

Decelerating, in particular pronounced or abrupt decelerating, can also lead to a load on the conveyor unit. Accordingly, a deceleration of the conveyor unit can be effected with a first braking effect that is in particular continuously increased toward a second braking effect within a predetermined duration to reduce or even eliminate pronounced or abrupt deceleration.

The measuring unit can be adapted to detect the start-up and/or deceleration, in particular an acceleration and/or a deceleration delay of the conveyor unit. The controller can be adapted to control a drive unit driving the conveyor unit such that the load on the conveyor unit is reduced, or is as low as possible, during startup and deceleration. For this purpose, the controller can output an acceleration command to start up the drive unit, wherein the acceleration command comprises the adjusted acceleration. The controller can further output a deceleration delay command to the drive unit, wherein the deceleration delay command comprises decelerating with the first and the second braking effect.

The appointed maintenance time can be determined based on the knowledge of the influence of the at least one operating parameter on the expected service life of the conveyor unit. The appointed maintenance time is a time in the future when the conveyor unit must be serviced to extend the expected service life of the conveyor unit, or to maximize the expected service life of the conveyor unit by replacing the conveyor unit with a new conveyor unit, or to counteract an unplanned malfunction. The time can be a month, a week, a day, or an hour of a day.

The controller can be adapted to determine the appointed maintenance time as a function of the expected service life such that it corresponds to an expected end of the expected service life or represents a predetermined time interval prior to the expected end. Accordingly, the appointed maintenance time can be selected such that there is one month, one or several weeks, one or several days, or one or several hours between the expected end and the appointed maintenance time. Consequently, a safety margin can be built in to prevent possible misjudgments of the expected service life, supply shortages of a new conveyor unit and/or individual elements of the conveyor unit, and/or a shortage of personnel to carry out the maintenance.

Individual elements of the conveyor unit can have a conveyor unit tension controller, in particular a chain tension controller or parts thereof, a cylinder of the chain tension controller, fasteners of the conveyor unit, a conveyor unit segment, in particular a chain link, a bearing of the conveyor unit, in particular a bearing of a chain link, a drive wheel guiding a conveyor unit, in particular a chain-guiding sprocket, a guide unit, in particular a guide rail, and a transport pin of the conveyor unit.

The system can comprise the chain guide or several chain guides. The chain guide can be adapted to guide the conveyor unit. At least one chain guide can be arranged upstream of a first section for drying the container units. In particular, the at least one chain guide can be arranged along the conveyor unit upstream of the conveyor unit tension controller. At least one or more chain guides can be arranged downstream of a cooling zone and upstream of the first section for drying the container units.

The expected appointed maintenance time of the conveyor unit can characterize at least one time at which the detected elongation has a predetermined value, wherein the predetermined value is less than or equal to, and/or less than, 5%, 3%, in particular 1%. The elongation is a parameter for the elongation of the conveyor unit and results from the comparison of the actual length to the original length of the conveyor unit or the length of the conveyor unit before its use. The elongation should not exceed the predetermined value to ensure the functionality of the conveyor unit.

The measuring unit can be adapted to determine the load on the conveyor unit based on oscillations of the conveyor unit. The conveyor unit can develop oscillations during operation, during startup, and while increasing and/or decreasing a conveyor speed. These oscillations can extend both in, or opposite to, the conveyance direction and represent a risk for the container units because these can fall due to the oscillations of the conveyor unit and/or individual process steps are negatively influenced. The oscillations can have an oscillation amplitude and/or frequency and can be described by means of these. The measuring unit can be adapted to determine the oscillations based on a pressure on at least one cylinder of the conveyor unit tension controller.

The controller can be adapted to determine one, or the, risk to the container units based on the detected oscillations, wherein the controller is in particular adapted to control the conveyor unit based on the detected oscillations such that the risk to the container units is reduced to a minimum risk. The minimum risk is understood to be the risk for the container units present under normal operating conditions, in particular without oscillations. To reduce the risk to the minimum risk, the pressure on the cylinder can be dynamically compensated.

The measuring unit can be adapted to detect one or more deployment positions of the cylinder. The controller can furthermore be adapted to determine the elongation based on the deployment position or the deployment positions.

The measuring unit can be adapted to determine the friction, in particular the mean friction of the conveyor unit and/or the friction of the at least one individual element, in particular of the chain link and/or the bearing, based on a power consumption parameter of a drive unit of the conveyor unit. The power consumption parameter can be a torque of the drive unit, in particular of a drive sprocket of the drive unit. The power consumption parameter can comprise at least one of the following: an actual value of a power consumption, in particular the torque, the power consumption versus time, and a change in the power consumption. Since the power consumption parameter can also be dependent on other factors, the measuring unit can in particular be adapted to additionally determine at least an ambient temperature of the conveyor unit and/or the at least one individual element in order to determine the power consumption parameter. Without limitation, the power consumption versus time is an important criterion, and a change in power consumption should not exceed a value of less than or equal to, and/or less than, 1%, 0.5% or 0.1% per 24 hours.

The measuring unit can be adapted to determine the load on the conveyor unit based on the friction and/or the elongation of the conveyor unit. In particular, the temperature provides information about the friction of the conveyor unit or the at least one individual element.

To measure the temperature, the measuring unit can be adapted to receive infrared radiation of the conveyor unit and/or the at least one individual element. Friction can be determined in particular by means of an increased temperature, in particular in comparison to a rest state of the conveyor unit.

The measuring unit can furthermore be adapted to detect a temperature increase of at least one individual element in comparison to the rest of the conveyor unit, in particular in comparison to the other elements of the conveyor unit. The temperature increase should not exceed a value of less than or equal to, and/or less than, 10° C., in particular 5° C.

A vaporization of lubricants can be an exponential process. It can then be assumed that a temperature increase of the at least one individual element and/or the conveyor unit increases the consumption of lubricants by 50%.

The temperature increase of 10° C. can lead to a reduction in the expected service life. The temperature increase of 10° C. can lead to an expected service life that is reduced by between 2 and 5%.

The controller can be adapted to control a lubrication of the conveyor unit based on the friction of the conveyor unit, in particular based on the temperature of the conveyor unit and/or the at least one individual element. By lubricating the conveyor unit or the at least one individual element, the temperature of the conveyor unit and/or the temperature of the at least one individual element can be reduced because a lower friction can be achieved by lubricating. Accordingly, the load on the conveyor unit and/or on the at least one individual element can also be reduced. As a result, the expected service life of the conveyor unit can be increased.

The measuring unit can be a light curtain, a proximity switch, a metal detector, a vibration/, sound/and/or temperature measuring unit to determine the temperature of the conveyor unit, a bearing quality of the bearings of the conveyor unit and/or the lubrication of the conveyor unit.

The system can comprise a lubrication unit adapted to lubricate the conveyor unit with a lubricant. Additionally or alternatively, the measuring unit can be adapted to determine a bearing state of one or more bearings of the conveyor unit as the friction, the damage, and/or load of the conveyor unit and/or of the one or more bearings of the conveyor unit, wherein the controller is in particular adapted to control the lubrication unit based on the friction, the damage, and/or the load on the conveyor unit and/or the one or more bearings of the conveyor unit.

The conveyor unit can comprise a guide unit, in particular a chain guide for guiding the conveyor unit, wherein the measuring unit is adapted to detect the friction of the conveyor unit based on a guide temperature of the conveyor unit and/or the at least one individual element upstream and/or downstream of the guide unit. The control temperature is a temperature of the conveyor unit and/or the at least one individual element upstream and/or downstream of the guide unit. The controller can in particular be adapted to determine an adjustment error of the guide unit based on the determined friction upstream and/or downstream of the guide unit of the conveyor unit and/or the at least one individual element and to correct the guide unit based on the adjustment error and/or to output a warning signal. The chain guide can be improperly adjusted, in particular too tightly, which can be determined by a temperature measurement downstream and/or upstream of the guide rail. The measuring unit can further be adapted to determine the friction of the conveyor unit and/or the at least one individual element upstream and/or downstream of the guide unit based on a torque and/or a power consumption of the drive unit. The controller can further be adapted to receive a data input to check an adjustment of the guide unit and to identify and correct the adjustment error as needed.

The measuring unit can be adapted to detect the load based on a torque of the drive unit and to detect the load and/or the damage based on an increase in the torque of the drive unit under substantially identical conditions. The controller can in particular be adapted to determine at least one defective bearing and/or an insufficient lubrication of the conveyor unit based on the increased torque. The controller can further be adapted to output a signal characterizing the defective bearing, the signal indicating a position of the defective bearing.

The measuring unit can be adapted to determine the damage to the conveyor unit based on a breakage and/or an absence of at least one transport pin of the transport pins of the conveyor unit. The measuring unit can be a light curtain. The measuring unit can be arranged in the region of the conveyor unit return guide, in particular the chain return guide. The measuring unit can furthermore be adapted to detect a position of the break and/or the missing transport pin such that the position of the break and/or the missing transport pin is known.

The controller can determine the expected service life as a function of a number of missing transport pins. The expected service life can be determined by counting the missing transport pins in combination with a temporal correlation. The expected service life can be achieved if greater than or equal to, and/or greater than, five transport pins, in particular 10 transport pins, are missing.

Based on the breakage, the absence of the at least one transport pin, the number of missing transport pins, in particular the positions of the broken and/or missing transport pins, the controller can further be adapted to control a decorator of the system or the oven such that no container unit is directed to a location with a defect. A defect can be a broken or missing transport pin. The system can comprise the decorator. The decorator can be adapted to imprint the container units.

The system can comprise two or more measuring units. The two measuring units can be arranged on at least one section of the system or the oven and can be adapted to detect the at least one operating parameter of the conveyor unit on the at least one section. Alternatively, at least one measuring unit can be arranged on each section of the system or the oven and can be adapted to detect the at least one operating parameter of the conveyor unit on the respective section.

The two or more measuring units can be, or comprise, light curtains and can be arranged on predetermined sections of the system or the oven. The light curtains can be adapted to detect container units and/or the absence of container units. In particular, at least one light curtain can be installed upstream of a decorator and/or in upstream of a pre-drying frame, downstream of the pre-drying frame and/or upstream of an oven chamber of the oven, downstream of the oven chamber and/or upstream of a cooling zone, and in the conveyor unit return guide, in particular the chain return guide. The information acquired by the measuring units, in particular about the detected container units and/or the missing container units, can be provided to the controller.

The controller can be adapted to provide the at least one operating parameter, the warning signal, the maintenance signal, and/or the information acquired by the at least one measuring unit. The controller can in particular be adapted to output the operating parameter, the warning signal, the maintenance signal, and/or the information to operators, for example by means of a display.

The controller can be adapted to control the system based on the at least one operating parameter of the conveyor unit based on at least one of the following: a conveyor speed of the conveyor unit, of one or more makeup air, exhaust air, and/or recirculation units, and of a heating unit of. Based on the information of the missing container units, a rotational speed of the makeup air, exhaust air, cooling fan and/or recirculation units, and a heating output of the heating unit can in particular be reduced to conserve energy. The speeds and the heating output can be controlled such that these do not drop below a minimum speed and/or heating output or heating temperature relevant for the safety of the system or the oven, operators and/or for specified guidelines for the production of container units.

The controller can be adapted to control the conveyor unit based on the at least one operating parameter, in particular the load and the determined expected service life, such that the load is reduced to a minimum load. In particular, the controller can be adapted to control the lubrication and/or a start-up and/or deceleration behavior of the conveyor unit such that the load on the conveyor unit is reduced to the minimum load. For this purpose, the controller can command an increase or reduction of the conveyor speed in stages or continuously. Lubrication can be a minimum lubrication equivalent to the lubrication required for current operation. Consequently, the friction of the conveyor unit and a lubricant introduction into the system or the oven is reduced to a minimum.

The controller can further be adapted to further determine the expected service life based on the materials used to construct the conveyor unit, in particular the at least individual element.

The controller can be adapted to determine the at least one individual element of the conveyor unit and/or one unit of the system or oven or several elements of the conveyor unit and/or units of the system or the oven that must be maintained at the appointed maintenance time.

The controller can be, or comprise, a processor, a logic module, an IC, an ASCI, an FPGA, a computing processor, or the like. The controller can be a computer. The processor can be a CPU or an integrated circuit in the form of a microprocessor or microcontroller. The controller can further comprise a memory. The memory can be nonvolatile. The memory can be adapted to store data, in particular from the measuring unit. A computer program product according to the aspect described below can be stored in the memory.

The at least one operating parameter can be detected by a measuring unit and/or obtained by the measuring unit.

The proposed system can be used to achieve an optimized lubrication of the conveyor unit, a soft start-up and deceleration behavior, and thus a reduced load on the conveyor unit.

The object is achieved by an oven, in particular a pin oven, comprising a system according to the first aspect and/or a system according to the second aspect.

The measuring unit of the system can be adapted to detect a number of container units transported through the oven, in particular to detect container units transported by means of the conveyor unit upstream and downstream of at least one section of the oven, wherein the controller is adapted to output a signal indicating a can count in the event of a deviation of the number of container units upstream and downstream of the section, said signal characterizing the number of container units upstream and downstream of the section and/or the deviation of the count.

The oven can comprise additional units. The further units can comprise at least one of the following: a stabilization unit, a circulating air fluid unit, a heating unit, a fluid flow device, a cooling fluid unit, a bottom coater, a cooling zone, a fluid inlet device, a container remover and a fluid outlet device.

The object is further achieved by a method for an early detection of a malfunction of a conveyor unit of a conveyor system for conveying container units, in particular cans, along an oven. The method comprises the steps: detect at least one operating parameter of the conveyor system; compare the operating parameter to a target operating parameter; detect a deviation of the operating parameter from the target operating parameter at a detection time; output a warning signal if the deviation is greater than or equal to a predetermined value after a predetermined duration, wherein the duration begins with the detection time.

The object is further achieved by a method for an early detection of a malfunction of a conveyor unit of a conveyor system for conveying container units, in particular cans, along an oven. The method comprises the steps: detect at least one operating parameter of the conveyor system, in particular of the conveyor unit, that has an influence on a service life of the conveyor unit; determine an expected service life of the conveyor unit based on the at least one operating parameter; output a maintenance signal based on the expected service life of the conveyor unit that characterizes an expected appointed maintenance time of the conveyor unit.

The object is further achieved by a computer program product for an early detection of a malfunction of a conveyor unit of an oven, comprising commands that cause a processor to execute a method according to one of the aspects described above when the program is executed by the processor.

Further advantageous embodiments of these aspects are indicated in the respective dependent patent claims. The features listed individually in the patent claims and the description can be combined with one another in any technologically meaningful way, whereby further embodiments of the invention are shown.

The methods and their possible further embodiments indicate features and/or method steps that in particular render them suitable for use in systems and/or an oven, in particular a pin oven, comprised of at least one such system.

For further advantages, embodiment variants and embodiment details of the further aspects and their possible further embodiments, reference is also made to the previous description of the corresponding features and further embodiments of the systems and methods.

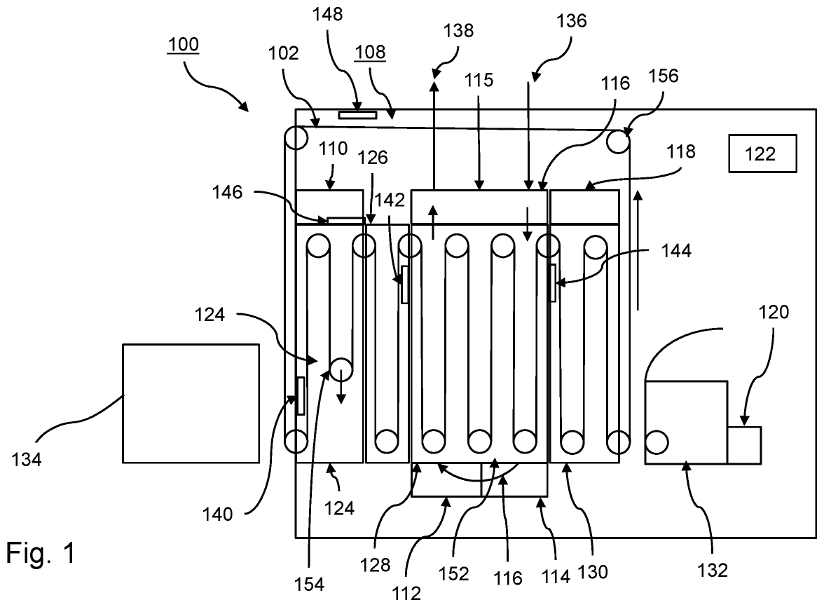

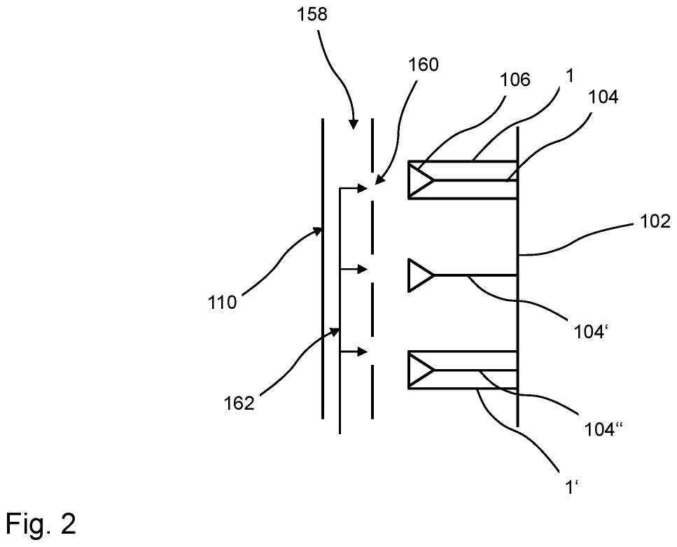

FIG. 1 shows an oven, in particular a pin oven 100. The pin oven 100 comprises a conveyor system having at least one conveyor unit 102 adapted as a chain conveyor or chain. The conveyor unit 102 comprises the transport pins 104, 104′, 104″ shown in FIG. 2. Container units 1, 1′ can be arranged on the transport pins 104, 104′, 104″ and can thus be transported along the meander-shaped drying path shown in FIG. 1. The pin oven 100 further comprises a circulating air fluid unit 112, a fluid flow unit 115, a cooling fluid unit 118, and a container removal unit 120.

The container units 1, 1′ are printed or coated in a decorator 134 (not comprised by the pin oven 100) in particular with an enamel. The container units 1, 1′ are transferred from the decorator 134 to the pin oven 100. The decorator 134 and the pin oven 100 can be coupled to one another such that the decorator 134 drives the conveyor unit 102. The container units 1, 1′ then enter a pre-drying frame 124. The chain tension controller 154 is provided within the pre-drying frame 124, which tensions the chain of the conveyor unit 102 such that it always has a predefined tension. Downstream of the pre-drying frame 124, the pin oven 100 has a bottom coater 126. Downstream of the bottom coater 126, the pin oven 100 has an oven unit 128.

The oven unit 128 forms an oven chamber 152 in which the container units 1, 1′ are heated to a high temperature. For this purpose, the oven unit 128 comprises a heating unit 114. The heating unit 114 can be a gas burner, for example. The heating unit 114 is coupled to a circulating air fluid unit 112, which moves the fluid flow in a fluid flow direction 116, i.e. first from the oven chamber 152 into the heating unit 114, then into a circulating air fluid unit 112 and then back into the oven chamber 152. In this way, a heated fluid flow is made available to the oven chamber 152. The oven unit 128 is furthermore coupled to a fluid flow unit 115. The fluid flow unit 115 is arranged and configured to provide a fluid from the environment of the pin oven 100 to the oven unit 128 and to supply a fluid out of the oven unit 128. For this purpose, the pin oven has a fluid inlet device 136 and a fluid outlet device 138.

A cooling zone 130 is provided further downstream of the oven unit 128. The cooling zone 130 is optional for the pin oven 100 and is generally not absolutely necessary. A cooling fluid unit 118 is arranged and adapted in the cooling zone 130 in order to cool the container units 1, 1′ with a fluid flow. A container extractor 132 is located at the outlet of the cooling fluid unit 118. The container extractor 132 has a container removal unit 120 which exerts a negative pressure on the bottoms of the container units 1, 1′ by means of a fluid flow and thus removes them from the conveyor unit 102 and can move them to a downstream process step.

As described above, the conveyor unit 102 conveys the container units 1, 1′ along a drying section, which runs through the pre-drying frame 124, the oven unit 128 and the cooling zone 130. After the conveyor unit 102 has transferred the container units 1, 1′ to the container extractor 132, the conveyor unit 102 is returned to the printing device 134 by means of rollers 156. Consequently, the conveyor unit 102 is a key component of the drying processes and any unforeseen downtime of the conveyor unit 102 can represent a cost and production risk. Furthermore, the conveyor unit 102 represents a wear part that must be maintained in order to ensure process reliability.

In order to prevent a malfunction of the conveyor unit 102, a system 108 comprises a controller 122 and at least one measuring unit 140, 142, 144, 146, 148. The controller 122 can comprise a processor for executing a computer program product.

The following description describes the system 108 as a combination system consisting of two systems, wherein one outputs a warning signal and the other outputs an appointed maintenance time. It is obvious to the person skilled in the art that the systems can also be provided independently of one another. The following description therefore does not limit the invention to the combination system.

The at least one measuring unit 140, 142, 144, 146, 148 is adapted to detect at least one operating parameter of the conveyor system, in particular of the conveyor unit 102. The controller 122 is adapted to compare the at least one operating parameter to a target operating parameter. The controller 122 detects a deviation between the operating parameter and the target operating parameter at a detection time. The controller 122 further outputs a warning signal if the deviation is greater than or equal to, or greater than, a predetermined value after a predetermined duration, wherein the duration starts at the detection time. The deviation can indicate a defective element of the conveyor unit 102, and an operator can be informed accordingly by the warning signal to inspect the element. Accordingly, a malfunction of the conveyor unit 102 can be prevented.

According to FIG. 1, a plurality of operating parameters are recorded by means of the measuring units 140, 142, 144, 146, 148. The controller 122 can be adapted to compare two or more of the detected operating parameters to the respective target operating parameters assigned to the detected operating parameter. The operating parameters can belong to different types of parameters, such as temperature, friction, speed, etc. For each type, a corresponding target operating parameter can be selected and/or set by a user. Consequently, individual target operating parameters can be selected for each operating parameter and/or type. Furthermore, individual durations can be selected for the operating parameters and/or types. For example, a duration for the operating parameter of the conveyor speed of the conveyor unit 102 can be selected to be relatively short, for example 10 seconds, because an increased speed can lead to a can jam and/or to faulty production. This should therefore be detected quickly. On the other hand, a duration for the operating parameter of a bearing temperature can be set to 5 minutes because the heating up of the bearing can potentially occur quickly, whereas a cooling down, for example by increasing the lubricant, takes longer. Thus, a longer observation period makes sense in order to detect a cooling of the bearing and to avoid outputting a warning signal.

In order to determine an appointed maintenance time of the conveyor unit 102, the controller 122 is further adapted to determine an expected service life of the conveyor unit 102 based on the at least one operating parameter. Based on the expected service life, an appointed maintenance time of the conveyor unit 102 can be determined in the future. The appointed maintenance time can be before the expected end of the service life of the conveyor unit 102.

The controller 122 can be connected by signal technology to individual or all elements of a system 108 or the pin oven 100, in particular to the conveyor unit 102 and to the measuring units of the system 108 or the pin oven 100, as well as other elements. The controller 122 can send and receive information and signals to and from the elements, respectively.

In order to determine the expected service life of the conveyor unit 102 and to determine a deviation from a target operating parameter, several operating parameters are determined by means of measuring units according to FIG. 1. Without limitation, these operating parameters include friction, elongation, damage and a load on the conveyor unit 102, wherein the operating parameters are output to the controller 122. Damage is understood to mean any type of defect and/or damage to the conveyor unit 102. Transport pins 104, 104′, 104″ can, without limitation, break off or deviate from their factory state such that they at least partially no longer meet the process requirements. Without limitation, damage to bearings and/or chain links of the conveyor unit 102 can also occur, such damage is likewise defined as damage to the conveyor unit 102. The load is defined to include, without limitation, forces exerted on the conveyor unit 102, such as exerted tensile forces, for example tensile stresses exerted by the chain tension controller 154 or forces exerted by a drive unit, in particular by a drive wheel of the conveyor unit 102. An exposure to fluid flows, temperatures, temperature fluctuations and weights of the container units 1, 1′ can furthermore be defined as the load on the conveyor unit 102. In particular, the conveyor unit 102 can experience vibrations, which represents a mechanical load on the conveyor unit 102. The oscillations can arise from a start-up, acceleration and/or deceleration of the conveyor unit 102. The load can, without limitation, also be determined on the basis of a friction of the conveyor unit 102. To detect the operating parameters, a measuring unit can comprise one or more of the following: a proximity switch, a light curtain, a metal detector, a camera, an infrared sensor, a temperature sensor, a vibration sensor and a sound sensor.

A first measuring unit 140 according to FIG. 1 comprises a light curtain adapted to detect any damage to these, and/or to the container units 1, 1′ transported by said transport pins 104, 104′, 104″. The first measuring unit 140 is further adapted to detect the presence and/or absence of container units 1, 1′ and a corresponding position, wherein the absence is likewise defined as damage. The first measuring unit 140 and further measuring units are coupled to the controller 122 by signal technology, wherein the controller 122 receives from the measuring units the operating parameters detected by the measuring units, and can processes said parameters. Based on the operating parameter defined as damage, in particular the absence of transport pins 104, 104′, 104″ or broken transport pins 104, 104′, 104″, the decorator 134 can be controlled by the controller 122 such that the decorator 134 only controls the existing, preferably functional, transport pins 104, 104′, 104″.

Previous and subsequent embodiments relating to a measuring unit or the first measuring unit 140 can be applied to other measuring units.

A second measuring unit 142, which is or comprises a light curtain, is arranged upstream of the oven unit 128. Like the first measuring unit 140, the second measuring unit 142 detects the transport pins 104, 104′, 104″ as well as the container units 1, 1′ and is coupled to the controller 122 by signal technology.

A third measuring unit 144, which is or comprises a light curtain, is arranged downstream of the oven unit 128, and is adapted like the first and second measuring units 140, 142 and coupled to the controller 122 by signal technology. By means of the first to third measuring units 140, 142, 144, in particular the second and third measuring units 142, 144, a quantity of container units 1, 1′ is known along the drying path, in particular upstream and downstream of the oven unit 128. If the quantity of container units 1, 1′ changes along the drying path, the controller 122 can determine that one or more container units 1, 1′ have fallen off the conveyor unit 102 upstream, downstream of, or during, what section.

A fourth measuring unit 146 comprising a temperature sensor is arranged in the pre-drying frame 124 and is adapted to detect a temperature of the conveyor unit 102, in particular of at least one individual element of the conveyor unit 102. An individual element of the conveyor unit 102 can be a cylinder, a bearing, a conveyor unit section, a chain link, or another element of the conveyor unit 102. Furthermore, a mean temperature of the conveyor unit 102 can be calculated based on the temperatures of individual elements and/or sections, in particular conveyor unit sections of the conveyor unit 102. Based on the temperature, a friction of the conveyor unit 102 or the individual elements can be determined. Without limitation, the friction is an operating parameter that has an influence on an expected service life of the conveyor unit 102.

The fourth measuring unit 146 can be adapted to record a mean friction (average friction) of the chain links of the conveyor unit 102 during startup or acceleration of the chain based on a power consumption of the drive wheel of the conveyor unit 102 or a torque measurement of the drive wheel. Since the torque can still be dependent on other factors, the fourth measuring unit 146 can further record an ambient temperature of the conveyor unit 102, in particular within the pin oven 100, preferably within the drying frame 124 and/or the oven unit 128. The fourth measuring unit 146 can be adapted to detect a change in the power consumption, the torque and/or the ambient temperature.

The fourth measuring unit 146 can furthermore be adapted to determine the load and/or damage to the conveyor unit 102 based on the detected torque. In particular, the torque can increase under substantially identical conditions, which can indicate a defective bearing. The controller 122 can be adapted to determine the defective bearing and/or an insufficient lubrication based on the detected torque and/or the change in torque.

Based on a temperature of one or more bearings of the conveyor unit 102 or the chain-guiding gear sprockets, the friction, and thus a load, on the bearings can be inferred. In order to keep this load even and as low as possible, the bearings and the chain of the conveyor unit 102 are lubricated. The lubrication is carried out by a lubrication unit (not shown), which is arranged and adapted to lubricate the conveyor unit 102 with a lubricant. The controller 122 is adapted to control the lubrication unit based on the detected operating parameters, in particular the temperature, friction and/or load on the conveyor unit 102, in particular the individual elements such as the bearings. Accordingly, the controller 122 can introduce more lubricant, for example in the case of a high friction, in order to reduce the friction. The controller 122 can lubricate the conveyor unit 102 by means of the lubrication unit such that a necessary minimum lubrication takes place. The fourth measuring unit 146 can further comprise a vibration and/or sound sensor in order to detect a bearing quality of the bearings.

A fifth measuring unit 148 is arranged on the return guide of the conveyor unit 102 and is adapted to detect the elongation of the conveyor unit 102. In particular, the fifth measuring unit 148 is adapted to detect a cylinder position of a cylinder of the chain tension controller 154. The elongation can be determined based on the cylinder position. The controller 122 is adapted such that the expected appointed maintenance time of the conveyor unit 102 characterizes at least one point in time at which the detected elongation has a predetermined value, wherein the predetermined value is less than or equal to 5%, 3%, in particular 1%. The predetermined value can be set by a user or correspond to a preprogrammed value. For each conveyor unit used, a predetermined value can in particular be stored in the controller 122.

The controller 122 can have a memory and/or a transceiver. The memory is set up to store operating parameters and information as well as a computer program product. The transceiver is adapted to send and receive the operating parameters and information, in particular wirelessly.

The fifth measuring unit 148 is further adapted to detect a pressure, in particular a function of time versus the pressure on the cylinder of the chain tension controller 154 and to determine the oscillations of the conveyor unit 102 based on the pressure, in particular the function of time versus pressure. The controller 122 can determine a risk for the container units 1, 1′ by means of these oscillations. Due to the oscillations, the container units 1, 1′ can fall off the conveyor unit 102. Consequently, this can represent a risk of loss and/or damage to the container units 1, 1′. In order to reduce this risk to a minimum risk, the controller 122 is adapted to control the conveyor unit 122, in particular the chain tension controller 154, based on the oscillations. For this purpose, the controller 122 can control the chain tension controller 154 such that the pressure on the cylinder is dynamically compensated to smooth the oscillation amplitude and/or reduce the oscillation frequency. In particular in the area of the drying path, the controller 122 is adapted to control the conveyor unit 102, in particular the chain tension controller 154, by taking into account the distances, in particular the time intervals between the transport pins 104, 104′, 104″, in order to reduce the oscillations.

The fifth measuring unit 148 is further adapted to detect a cylinder force of the cylinder to determine a chain tension of the conveyor unit 102. The controller 122 can further control the conveyor unit 122 based on the chain tension, in particular such that the oscillations are reduced. By reducing the oscillations, not only the risk for the container units 1, 1′ can be reduced; the load on the conveyor unit 102 can also be reduced.

In FIG. 1, the system 108 comprises at least the controller 122 and the measuring units 140, 142, 144, 146, 148. The system 108 can comprise fewer, or a plurality of further, units and/or sections of the pin oven 100, for example the conveyor unit 102.

By means of the detected operating parameters, the controller 122 determines the expected service life and the appointed maintenance time. The operating parameters negatively impact, and shorten, the expected service life. An expected service life can be specified by a manufacturer. In particular, the specification can be provided in connection with various average operating parameters, such as an average conveyor speed, an average temperature, etc. The controller 122 can determine the expected service life based on the expected service life and the operating parameters recorded by means of the measuring units. For this purpose, the controller 122 can in particular determine deviations of the detected operating parameters from the operating parameters specified by the manufacturer and determine an influence on the expected service life. The controller can further determine the expected service life based on a temporal correlation of the operating parameters.

FIG. 2 shows a detail of the pin oven 100, namely the stabilizing unit 110. The stabilization unit 110 comprises an air duct 158. Openings 160 are provided on one side of the air duct 158. A fluid flow 162 guided in the air duct 158 exits through the opening 160 and from there exerts a fluid pressure on the container units 1, 1′. Due to this pressure, the container units 1, 1′ are pressed onto the transport pins 104, 104′, 104″ or onto the holding element 106 of the transport pins 104, 104′, 104″. As a result, the container units 1, 1′ are stabilized.

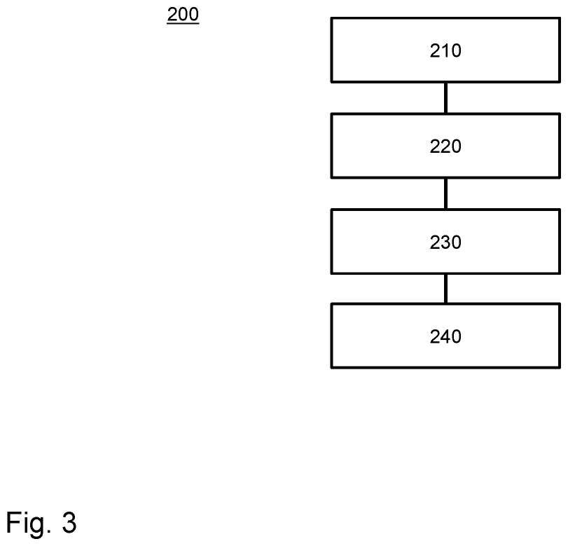

FIG. 3 shows a schematic illustration of a method 200 for an early detection of a malfunction of a conveyor system, in particular a conveyor unit 102 for conveying container units 1, 1′ along a drying path of an oven. The method 200 comprises a detection 210 of at least one operating parameter of the conveyor system. The method 200 further comprises a comparison 220 of the operating parameter to a target operating parameter and a detection 230 of a deviation of the operating parameter from the target operating parameter at a detection time.

The method further comprises an output 240 of a warning signal if the deviation is greater than or equal to, or greater than, a predetermined value after a predetermined duration, wherein the duration begins with the detection time.

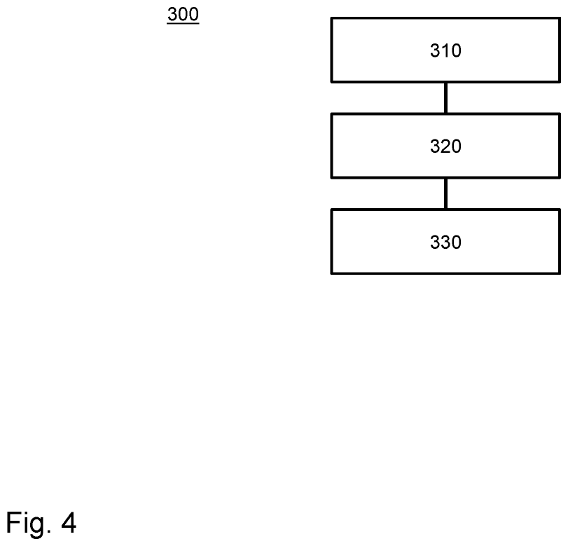

FIG. 4 shows a schematic illustration of a method 300 for the early detection of a malfunction of a conveyor system, in particular a conveyor unit 102 for conveying container units 1, 1′ along a drying path of an oven. The method 300 comprises a detection 310 of at least one operating parameter of the conveyor system, in particular the conveyor unit 102, that has an influence on a service life of the conveyor unit 102, and a determination 320 of an expected service life of the conveyor unit 102 based on the at least one operating parameter of the conveyor unit. The method further comprises generating 330 a maintenance signal based on the expected service life of the conveyor unit 102, said signal characterizing an expected appointed maintenance time of the conveyor unit.

### REFERENCE SYMBOLS

1, 1′ Container unit
100 Pin oven
102 Conveyor unit
104, 104′, 104″ Transport pin
106 Holding element
108 System
110 Stabilization unit
112 Circulating air fluid unit
114 Heating unit
115 Fluid flow device
116 Fluid flow direction
118 Cooling fluid unit
120 Container removal unit
122 Controller
124 Pre-drying frame
126 Floor coater
128 Oven unit
130 Cooling zone
132 Container puller
134 Decorator
136 Fluid inlet device
138 Fluid outlet device
140 First measuring unit
142 Second measuring unit
144 Third measuring unit
146 Fourth measuring unit
148 Fifth measuring unit
152 Oven chamber
154 Chain tension controller
156 Roller
158 Air duct
160 Openings
162 Fluid flow
200 Method for early detection of a malfunction of a conveyor system
210 Determine at least one operating parameter of the conveyor system
220 Compare the operating parameter to a target operating parameter
230 Determine a deviation of the operating parameter from the target operating parameter
240 Output a warning signal
300 Method for drying container units
310 Determine at least one operating parameter of the conveyor system,
320 Determine an expected service life of the conveyor unit
330 Output a maintenance signal

1. A system for early detection of a malfunction of a conveyor unit of a conveyor system for conveying container units along a drying path of an oven, the system comprising:
at least one measuring unit configured to detect at least one operating parameter of the conveyor system; and
a controller configured to
compare the operating parameter to a target operating parameter,
determine a deviation of the operating parameter from the target operating parameter at a detection time, and
output a warning signal if the deviation is greater than or equal to a predetermined value after a predetermined duration, wherein the duration begins with the detection time.

2. The system according to claim 1, wherein the operating parameter comprises at least one of a friction, a damage, an elongation, a load, a temperature, a torque of drive unit driving the conveyor system, an ambient temperature, a lubrication cycle, a lubrication of the conveyor system, a fan speed of a fan unit of the oven, and a lubrication of at least one individual element of the conveyor system.

3. The system according to claim 1,
wherein the controller is further configured to determine an appointed maintenance time based on the deviation if the deviation is greater than or equal to the predetermined value during and/or after the predetermined duration, and
wherein the warning signal further characterizes the appointed maintenance time.

4. The system according to claim 1,
wherein the measuring unit is configured to detect the elongation based on a cylinder position of a conveyor unit tension controller of the conveyor unit of the conveyor system, and/or
wherein the predetermined value is greater than or equal to 5%.

5. The system according to claim 1, wherein the target operating parameter, the predetermined value, and the duration are selected based on the operating parameter to be detected.

6. The system according to claim 1,
wherein the operating parameter comprises at least one of the torque, the elongation, the friction, the temperature of the conveyor system, and the at least one individual element,
wherein the controller, when recording the deviation, is further configured to output a lubrication command to a lubrication unit for lubricating the conveyor system and/or the at least one individual element with a lubricant at least within the predetermined duration, and
wherein the controller is configured to output the lubrication command at the detection time and/or at a lubrication time that represents a predetermined time interval to the detection time and is within the predetermined duration.

7. The system according to claim 1,
wherein the controller is further configured to determine a lubricant quantity for lubricating the conveyor system and/or the at least one individual element based on at least the deviation, and the lubrication command characterizes the specified lubricant quantity, and
wherein the lubricant quantity is further determined based on at least one of a predetermined minimum lubricant limit, a predetermined maximum lubricant limit, and an actual lubricant quantity.

8. The system according to claim 1,
wherein the measuring unit is configured to determine a position information of the at least one individual element if the deviation is greater than or equal to the predetermined value after the predetermined duration,
wherein the position information includes at least one of an actual position and an expected position of the at least one individual element, and
wherein the warning signal comprises the position information.

9. The system according to claim 1,
wherein the measuring unit is configured to determine the load on the conveyor unit based on oscillations of the conveyor unit, and/or
wherein the controller is configured to determine a risk for the container units based on the detected oscillations, and
wherein the controller is configured to control the drive unit based on the detected oscillations.

10. The system according to claim 1,
wherein the controller is configured to control the drive unit such that the detected oscillations are reduced and/or compensated, and
wherein the conveyor unit comprises transport pins for conveying the container units through the oven, and the controller is configured to control the drive unit based on distances between the transport pins such that the detected oscillations are reduced and/or compensated.

11. The system according to claim 1,
wherein the controller is configured to control the drive unit and/or a conveyor unit tension of a conveyor unit tension controller of the conveyor system based on at least one of an age of the conveyor unit, the at least one individual element, a conveyor speed of the conveyor unit, the at least one operating parameter, and a container unit loss upstream, along, and/or downstream of a section of the oven.

12. The system according to claim 1,
wherein the measuring unit is configured to determine the friction of the conveyor unit and/or the friction of the at least one individual element based on a power consumption parameter of the drive unit,
wherein the power consumption parameter comprises at least one of an actual value of a power consumption, a power consumption versus time, and a change of the power consumption, and
wherein the measuring unit is configured to additionally determine an ambient temperature of the conveyor unit and/or of the at least one individual element to determine the power consumption parameter.

13. The system according to claim 1,
wherein the measuring unit is adapted to determine the friction of the conveyor unit based on the detected temperature of the conveyor unit and/or the friction of the at least one individual element based on the detected temperature of the at least one individual element.

14. The system according to claim 1,
wherein the measuring unit is configured to determine a bearing state of one or more bearings of the conveyor unit as the friction, damage, and/or load on the conveyor unit and/or of the one or more bearings of the conveyor unit, and
wherein the controller is configured to control the lubrication unit based on the friction, the damage and/or the load of the conveyor unit, and/or of the one or more bearings of the conveyor unit.

15. The system according to claim 1,
wherein the measuring unit is configured to detect the friction of the conveyor unit based on a control temperature of the conveyor unit and/or of the at least one individual element upstream and/or downstream of a guide unit of the conveyor unit, and
wherein the controller is configured to determine an adjustment error of the guide unit based on the friction determined upstream and/or downstream of the guide unit of the conveyor unit and/or of the at least one individual element and to output and/or determine a correction signal for correcting the guide unit and to output a correction signal together with the warning signal.

16. The system according to claim 1,
wherein the measuring unit is configured to determine the load based on a torque of the drive unit, and
wherein the controller is configured to determine at least one defective bearing and/or an insufficient lubrication of the conveyor unit if the deviation is greater than or equal to the predetermined value after the predetermined duration.

17. The system according to claim 1,
wherein the measuring unit is configured to determine the damage to the conveyor unit based on a breakage and/or an absence of at least one transport pin of the transport pins of the conveyor unit.

18. A system for an early detection of a malfunction of a conveyor unit of a conveyor system for conveying container units along a drying path of an oven, the system comprising:
at least one measuring unit configured to detect at least one operating parameter of the conveyor system that has an influence on a service life of a conveyor unit of the conveyor system; and
a controller configured to
determine an expected service life of the conveyor unit based on the at least one operating parameter, and
output a maintenance signal based on the expected service life of the conveyor unit that characterizes an expected appointed maintenance time of the conveyor unit.

19. A pin oven, comprising the system according to claim 1.

20. A method for an early detection of a malfunction of a conveyor unit of a conveyor system for conveying container units; along a drying path of an oven, the method comprising:
detecting at least one operating parameter of the conveyor system;
comparing the operating parameter to a target operating parameter;
determining a deviation of the operating parameter from the target operating parameter at a detection time; and
outputting a warning signal if the deviation is greater than or equal to a predetermined value after a predetermined duration, wherein the duration begins with the detection time.

21. A method for an early detection of a malfunction of a conveyor unit of a conveyor system for conveying container units along a drying path of an oven, the method comprising:
detecting at least one operating parameter of the conveyor system that has an influence on a service life of a conveyor unit of the conveyor system;
determining an expected service life of the conveyor unit based on the at least one operating parameter; and
outputting a maintenance signal based on the expected service life of the conveyor unit that characterizes an expected appointed maintenance time of the conveyor unit.

22. A computer program product for an early detection of a malfunction of a conveyor unit of a conveyor system for conveying container units, along a drying path of an oven, comprising commands that cause a processor to execute a method according to claim 20 when the program is executed by the processor.
